(19) United States
(12) Patent Application Publication
(10) Pub. No.: US 2026/0124101 A1
(43) Pub. Date: May 7, 2026

(54) MODULAR THERAPEUTIC DEVICE AND METHODS OF USE THEREOF

(71) Applicant: BUENAONDA LLC, Sedona, AZ (US)

(72) Inventor: Nicholas Scott Reynolds, New York, NY (US)

(21) Appl. No.: 19/439,650

(22) Filed: Jan. 5, 2026

Related U.S. Application Data
(63) Continuation of application No. 17/731,922, filed on Apr. 28, 2022.
(60) Provisional application No. 63/212,204, filed on Jun. 18, 2021.

(51) Int. Cl. A61H 15/00; A61H 23/02

(52) U.S. Cl. CPC A61H 15/00; A61H 23/0263; A61H 2015/005; A61H 2015/0071; A61H 2201/0107; A61H 2201/1253

(57) ABSTRACT

The current invention includes a therapeutic medical device, specifically, a modular myofascial release device configured to perform directed, or self-directed myofascial release, deep tissue massage, or joint mobilization as a single or modular unit on a subject in need thereof.

### CROSS REFERENCE TO RELATED APPLICATIONS

This application claims the benefit of and priority to U.S. Provisional Application No. 63/212,204, filed Jun. 18, 2021. The entire specification and figures of the above-referenced application are hereby incorporated, in their entirety by reference.

### TECHNICAL FIELD

The present invention relates to a device and a method for a therapeutic device, and particularly a modular device configured for myofascial release therapy and deep tissue massage during physical therapy and as part of an ongoing program of self-care and maintenance.

### BACKGROUND OF THE INVENTION

Myofascial release is a type of soft tissue therapy utilizing tissue manipulation to achieve muscle relaxation via stretching and autogenic inhibition. Myofascial release techniques find applicability in many fields, including massage therapy, physical therapy, and chiropractic care, for example to correct or improve the health of multiple body parts and tissues such as muscles and fascia. When muscles are sore or damaged, they may contract. Contracted muscles may lead to immobility and pain in the area of the contracted muscle. Fascia is a connective tissue that covers muscles. Fascia can become restrictive from, for example, overuse, trauma, and inflammation, which may lead to adhesion formation, further muscle spasm, and decreased blood flow to the corresponding muscle.

Myofascial release techniques generally focus on relaxing contracted muscles and restricted fascia by stimulating proprioceptors and mechanoreceptors in the muscle of interest. Conventionally, myofascial release techniques include a therapist or chiropractor repeatedly pressing or “kneading” a muscle of interest until release is achieved. However, these techniques are laborious for the health care provider, often result in painful therapy for the patient, and allow the patient's reflexes to work against the health care provider, leading at times to less than favorable therapeutic results.

In many instances, patients may benefit from performing self-myofascial release and self-massage to treat a variety of conditions as notes above. Self-myofascial rollers are often utilized in self-myofascial release therapy. The self-myofascial devices are rolled across each muscle group (e.g., gastrocnemius, latissimus dorsi, piriformis, adductors, quadriceps, hamstrings, hip flexors, trapezius, rhomboids, and the tensor fasciae latae muscles), the user maintaining pressure from the self-myofascial roller on selected areas for selected periods of time. Self-myofascial rollers may be constructed of foam and/or hard plastics. Foam rollers tend to lose their shape with extended use, in turn decreasing the foam roller's ability to provide the requisite pressure for self-myofascial release. On the other hand, hard plastic rollers provide a consistently firm surface that can in turn be uncomfortable for the user. Self-myofascial rollers have been proposed that combine hard plastic cores with foam outer shells. These combination rollers alleviate some of the discomfort, but the foam outer shell eventually still loses its shape and effectiveness with extended use.

It is therefore desirable to provide therapeutic devices that can used by medical professionals and individual to perform self-myofascial release and self-massage that are comfortable, durable, effective, and that can be modularly adjusted to conform to a variety of body types, locations and therapeutic techniques.

### SUMMARY OF THE INVENTION

One aspect of the current invention includes a myofascial release device. In one preferred aspect, the myofascial release device of the invention may be configured to perform directed, such as by a medical professional, or self-directed myofascial release or deep tissue massage on a subject in need thereof. In this preferred aspect, the myofascial release device of the invention may be configured to perform directed, or self-directed myofascial release or deep tissue massage along the spine or one or more major muscle group, such as gastrocnemius, latissimus dorsi, piriformis, adductors, quadriceps, hamstrings, hip flexors, trapezius, rhomboids, and the tensor fasciae latae muscles in a subject in need thereof.

Another aspect of the current invention includes a modular myofascial release device. In one preferred aspect, the modular myofascial release device of the invention may be configured to perform directed, or self-directed myofascial release or deep tissue massage as a single or modular unit on a subject in need thereof. In one preferred embodiment, the modular myofascial release device may include a plurality of compression spheres coupled by a connector. Such coupling may be integral or transitory in nature. For example, in another preferred aspect, one or more compression spheres may be decoupled from the device and used for to perform directed, or self-directed myofascial release or deep tissue massage.

Another aspect of the current invention includes a vibrating modular myofascial release device. In one preferred aspect, the modular myofascial release device of the invention may be configured to perform directed, or self-directed myofascial release or deep tissue massage incorporating vibrational modalities. In this preferred aspect, one or more vibrational assemblies may be positioned in, or on the device and used for to perform vibrational directed, or self-directed myofascial release or deep tissue massage.

Another aspect of the current invention include coupler for a modular myofascial release device having two or more compression spheres coupled by a connector. In one preferred embodiment, the compression spheres can be disengaged from the connector and secured to a coupler configured to allow self-directed myofascial release or deep tissue massage. In this preferred embodiment, the coupler of the invention may be secured to a surface, such as the floor or wall such that the compression sphere is in an extended position allowing self-directed myofascial release or deep tissue massage by a subject in need thereof.

Another aspect of the current invention include methods of using a modular myofascial release device having two or more compression spheres coupled by a connectors, and in particularly for directed, or self-directed myofascial release or deep tissue massage along the spine or one or more major muscle group, such as gastrocnemius, latissimus dorsi, piriformis, adductors, quadriceps, hamstrings, hip flexors, trapezius, rhomboids, and the tensor fasciae latae muscles in a subject in need thereof.

Another aspect of the current invention includes methods of using a coupler for a modular myofascial release device for self-directed myofascial release or deep tissue massage. In this preferred embodiment, the coupler of the invention may be secured to a surface, such as the floor or wall such that the compression sphere is in an extended position allowing self-directed myofascial release or deep tissue massage along the spine or one or more major muscle group, such as gastrocnemius, latissimus dorsi, piriformis, adductors, quadriceps, hamstrings, hip flexors, trapezius, rhomboids, and the tensor fasciae latae muscles in a subject in need thereof.

### BRIEF DESCRIPTION OF THE DRAWINGS

FIG. 1 shows a perspective view of a modular myofascial release device in one embodiment thereof;

FIG. 2 shows a top view of a modular myofascial release device in one embodiment thereof;

FIG. 3 shows a bottom view of a modular myofascial release device in one embodiment thereof;

FIG. 4 shows a left view of a modular myofascial release device in one embodiment thereof;

FIG. 5 shows a right view of a modular myofascial release device in one embodiment thereof;

FIG. 6 shows a front view of a modular myofascial release device in one embodiment thereof;

FIG. 7 shows a back view of a modular myofascial release device in one embodiment thereof;

FIG. 8 shows a cross-sectional view of a modular myofascial release device in one embodiment thereof;

FIG. 9 shows a side view of a compression sphere and internally positioned channel in one embodiment thereof;

FIG. 10 shows a front view of a compression sphere having a channel in one embodiment thereof;

FIGS. 11A-D shows various use a modular myofascial release device on a subject in need thereof in one embodiment thereof;

FIGS. 12A-D shows various use the compression sphere of a modular myofascial release device on a subject in need thereof in one embodiment thereof; and

FIG. 13 shows a coupler device securing a compression sphere of a modular myofascial release device and its use on a subject in need thereof in one embodiment thereof.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

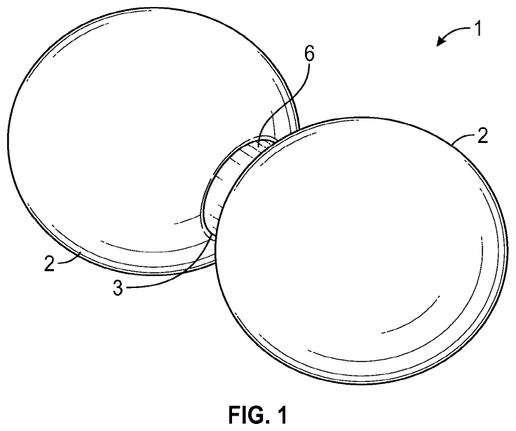

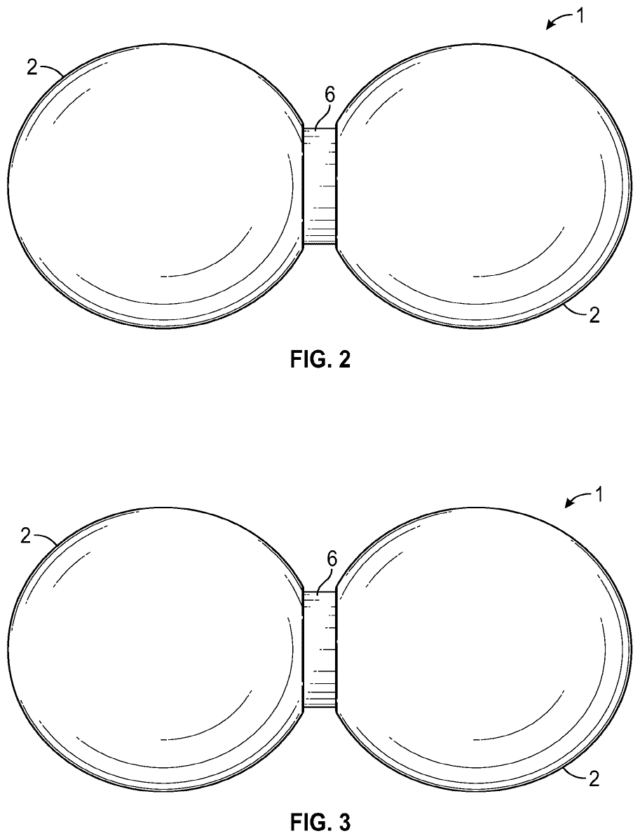

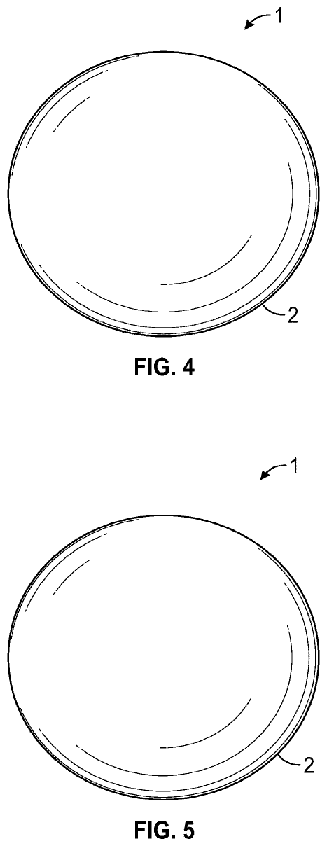

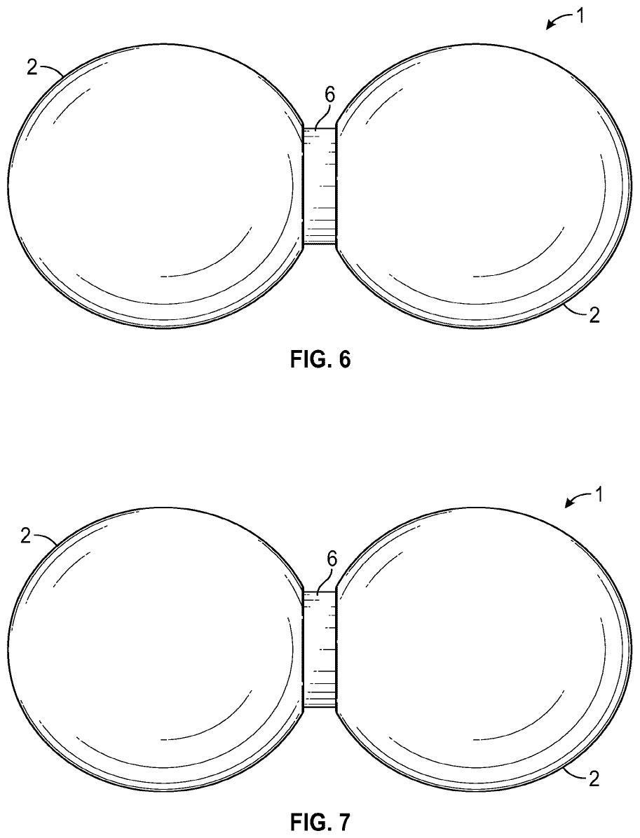

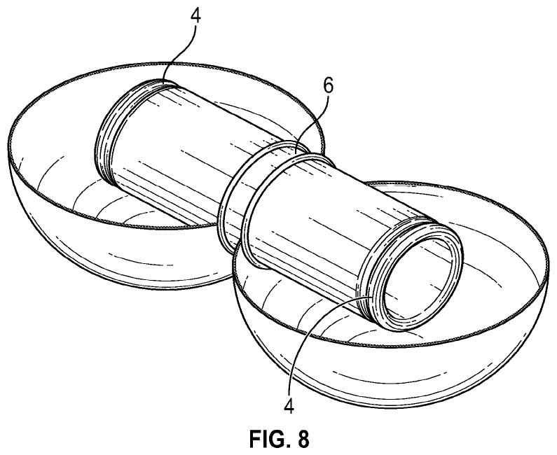

Generally referring to FIGS. 1-10, the invention may include a modular myofascial release device (1), which may be configured to perform directed or self-directed myofascial release or deep tissue massage on a subject in need thereof. As used herein with respect to the inventive device and methods of uses thereof, the term “directed” means myofascial release or deep tissue massage performed by, or under the direction or supervision of a third party, such as a medical professional, physical or massage therapist or other individual.

In one preferred embodiment, the myofascial release device (1) of the invention may include a plurality of compression spheres (2) that may be configured to provided sufficient compression and resilience in response to an applied force, such as compressive force applied when pressed against an anatomical feature of a subject, to provide a therapeutic degree of tension against the subject's muscle, fascia or other anatomical feature. In this embodiment, the compression spheres (2) of the invention may also be made from an elastomer material such as impact absorbing foams, ARTiLAGE artificial cartilage foam, Poron XRD foam, other ARTiLAGE foams, other Poron foams, silicone, silicone foams, rubber foams, plastic foams, or other elastomer materials such as elastic plastics, elastic silicone, elastic rubbers, silicone rubbers, or any other suitable substantially flexible material or combinations of materials.

In the preferred embodiment shown in FIGS. 1-10, the modular myofascial release device (1) of the invention may include two compressive spheres (2) coupled by a connector (6). In this embodiment, each compression sphere (2) may include a channel (3) configured to receive and/or secure a connector (6), which may preferably include a hollow connector (6) tube. In this embodiment, the channel (3) of the invention may include an integral annular channel penetrating approximately a portion of the length of the compressive sphere (2). (Notably, reference to such dimensions is exemplary only and not limiting on the various configurations that fall within the scope of the invention).

As noted above, the channel (3) of the invention may be configured to accommodate a hollow connector (6) components that may be inserted into the channel (3) of the compression sphere (2) and secured in position by the friction generated by the surface of the channel (3) against the compression sphere (2). Notably, as shown in FIG. 8, the friction as well as compressive force exerted by the elastomeric material of the compressive sphere (3), in this example being a silicone elastomer, is exerted against the outer and inner surfaces of the hollow connector (6).

In additional embodiments, the connector (6) may include one or more recessed notches (4) positioned along the length of the connector (6). In the preferred embodiment shown FIG. 8-10, the connector (6) of the invention may include a recessed notch (4) positioned at the terminal end of the connector (6). In this configuration, when inserted into the channel (6), the elastomeric material can expand and confirm to the recessed notch (4) as it traverses the channel (6). At the terminal end of the channel (6) may be positioned a corresponding extension (5) along the distal surface of the channel (3) which may be mated with the recessed notch (4) positioned at the terminal end of the connector (6).

In this configuration, when the connector (6) is inserted into a desired position in the channel (3), the extension (5) positioned along the outer surface of the channel (3) may mate with the recessed notch (4) on the outer surface of the connector (6) forming a secure connection further preventing undesired retraction of the connector (6) from the channel (3). As can be appreciated from the figures and disclosure, a user may apply a sufficient lateral force on one or more of the compression spheres (2) or connector (6) elements to overcome the frictional force holding the connector (6) in the channel (3). This applied force may further be sufficient to breck the connection between the flexible extension (5) positioned along the outer surface of the channel (3) and the recessed notch (4). As can further be appreciated from the figures and disclosure provided herein, in alternative embodiments, of the invention may include a plurality of flexible extensions (5) positioned along the outer surface of the channel (3) that may be mated with a corresponding number of recessed notches (4). Further, while showing in the figures as integral continuous annular notch, and extension, such elements may be non-integral, as well as non-continuous in some preferred embodiments.

In still further embodiments generally shown in FIGS. 8-10, the connector (6) may include one or more extensions (5) positioned along the length of the connector (6), and preferably at the terminal end of the connector (6). In this configuration, when inserted into the channel (6), the elastomeric material can expand and confirm to the extension (5) as it traverses the channel (6). At the terminal end of the channel (6) may be positioned a corresponding recessed notch (4) positioned along the outer surface of the channel (3) which may be mated with the extension (5) positioned at the terminal end of the connector (6). In this configuration, when the connector (6) is inserted into a desired position in the channel (3), the recessed notch (4) positioned along the outer surface of the channel (3) may mate with the extension (5) on the outer surface of the connector (6) forming a secure connection further preventing undesired retraction of the connector (6) from the channel (3).

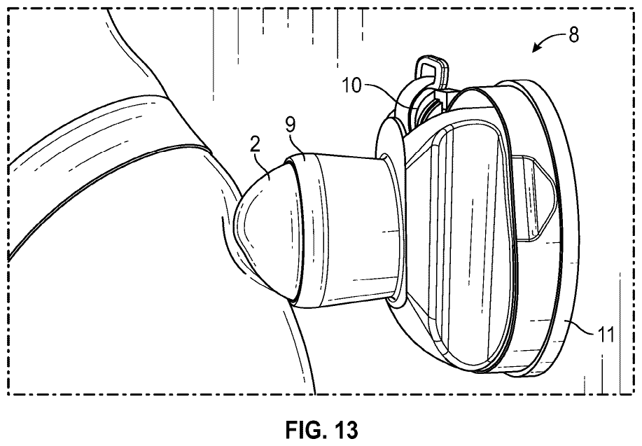

In still further embodiments the connector (6) of the invention may form a channel (6) that may be configured to house one or more vibrational assemblies (12) capable of transmitting vibrational energy to the modular myofascial release device (1) of the invention. As shown in FIG. 12, an exemplary vibrational assembly (12) is shown schematically. In a preferred embodiment, the vibrational assembly (12) of the invention includes an motor, and preferably an electric motor, coupled with a with a rotating shaft, and an eccentric flyweight supported by said shaft. Naturally, other designs for vibrational assemblies (12) can be incorporated into the invention and would be known to those of ordinary skill in the art.

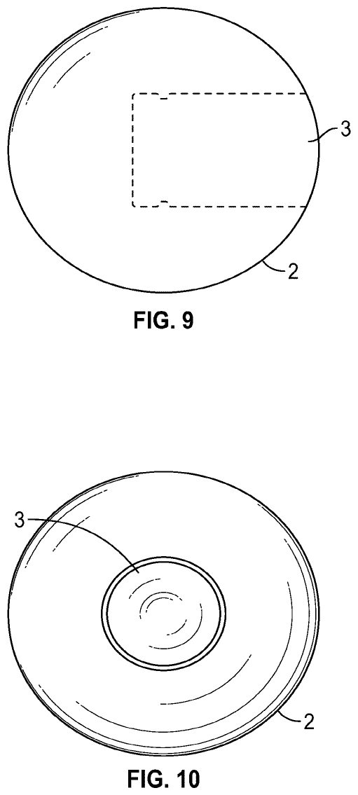

As also shown in FIG. 9, the vibrational assembly (12) of the invention further includes a controller (13), such as a programable printed circuit board (PCB) that may be responsive to a power source (14), such as a battery or electrical current from an direct source, such as an outlet. The vibrational assembly (not shown 12), controller (13) and power source (14) may be included in a single or separate housings. The placement of vibrational assembly (12) may be selected based upon the desired application and/or body part or parts to be treated. In some embodiments, two vibrational assemblies (12) are positioned at the distal ends of the channel (6) such that they are generally within the compression spheres (2). In alternative embodiments, one or more vibrational assemblies (12) are positioned at the center of the channel (6) such that they are partially or fully outside the compression spheres (2). In another embodiments, one or more vibrational assemblies (12) are positioned within a coupler (8) as described below, such that it transmit vibrational energy to a compression sphere (2) as shown in FIG. 13.

In a preferred embodiment, a user can activate or deactivate the vibrational assembly (12) manually, for example through a push button that is responsive to the controller (13). The vibration of the vibrational assemblies (12) positioned within a modular myofascial release device (1), or coupler (8) of the invention may be adjusted, for example by the controller, to vibrate at a one or more set frequencies or intensities, or may be adjusted by a user to be set at a desired vibration intensity and/or frequency. The vibrational assemblies (12) positioned within a modular myofascial release device (1), or coupler (8) of the invention may further comprise a device to emit heat. Such device may emit heat in any convenient manner such as, for example, convection, thermal, conduction, ultraviolet, and the like. This heating device may be located within the channel (6) or coupler (8), or via an attachment to the device.

In additional embodiments, the connector (6) of the invention may be separated from one or more compression sphere (2) and used as a linear myofascial release device. In this embodiment, the connector (6) of the invention may be rolled across one or more anatomical features of a user, such as major muscle groups, and effectuate myofascial release or deep tissue massage. Variable pressure may be applied by a user during self-directed myofascial release or deep tissue massage, or by a third party during directed myofascial release or deep tissue massage. In additional embodiment, the connector (6) of the invention may include a plurality of recessed notches (4), or extensions that may aid myofascial release or deep tissue massage applications.

Generally referring again to FIGS. 1-10, in alternative embodiments of the invention, the connector (6) may include a joint (7) securing separate halves of the connector (6). In this embodiment, the joint (7) of the invention may include a threaded type of joint, a clasp type joint, a clip type joint, a rivet type joint, a quick connect type joint, a push-to-lock type joint, a turn-to-lock type joint, a slide-to-lock type joint, or any other type of joint or joining method that is capable of temporarily joining disparate parts of the connector (6) as one reasonably skilled in the art could envision to serve the same function.

The invention may further include a coupler (8) configured to secure a modular myofascial release device (1), and more preferably one or more compression sphere (2) which may be configured to allow a user to self-administer myofascial release or deep tissue massage. In the preferred embodiment shown in FIG. 13, a coupler (8) may include a catch (9) configured to secure one or more compression spheres (2) of the invention. In this preferred embodiment, a compression sphere (2) may be removed from a modular myofascial release device (1) and secured within the catch (9) by a lock (10) or other locking type mechanisms configured to secure the compression sphere (2) in the coupler. This securement may be static, such that the compression sphere (2) is held in a stationary position, while in alternative embodiments, the securement may be rotatable, such that the compression sphere (2) is freely rotatable within the catch (9) in response, for example to an external force.

Referring again to FIG. 13, the coupler (8) of the invention may be attachment surface (11) configured to be secured to an external surface, such as an appropriate horizontal or vertical surface. In one embodiment, the attachment surface (11) of the coupler (8) may include a mount, adhesive surface, or a suction cup device configured to secure the coupler (8) in a stationary position, while in alternative embodiment, it may be configured to be mated with a separate pre-existing mount secured to a surface. In this configuration, a user can secure the coupler (8) of the invention to a desire surface and a pre-determined location to allow self-directed myofascial release or deep tissue massage on a select anatomical feature of muscle group.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

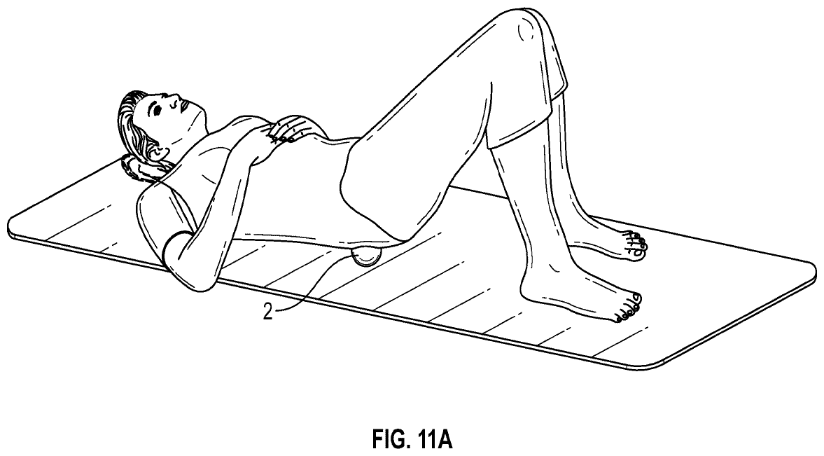

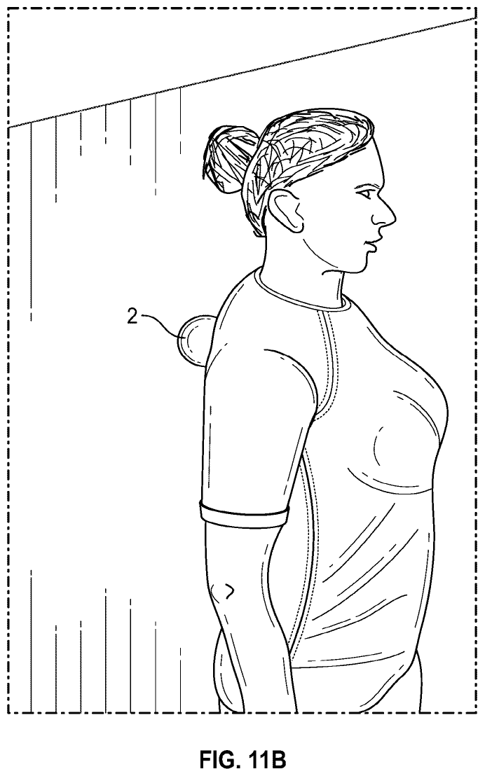

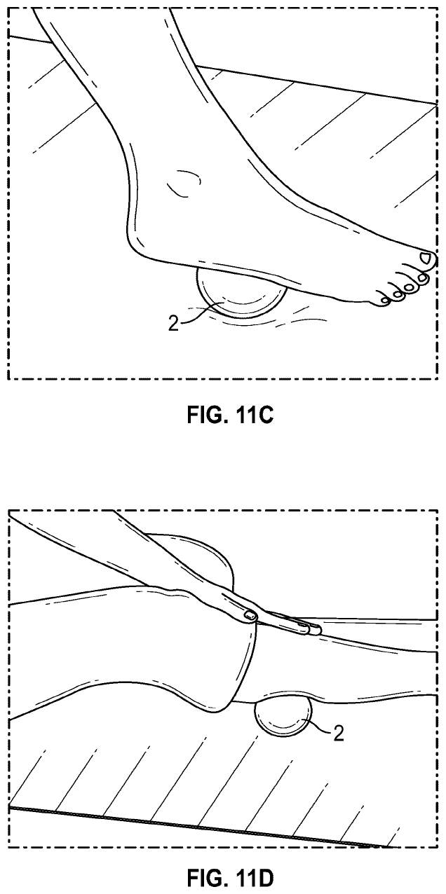

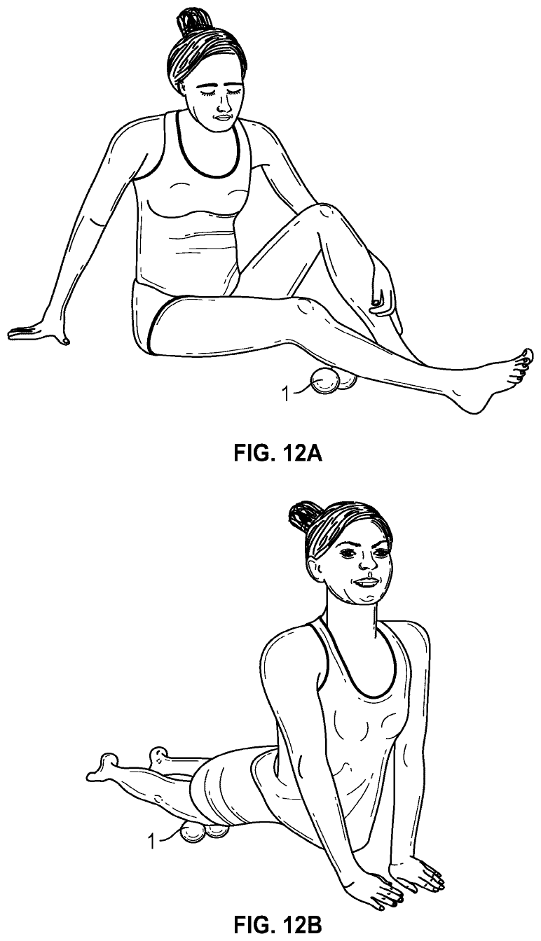

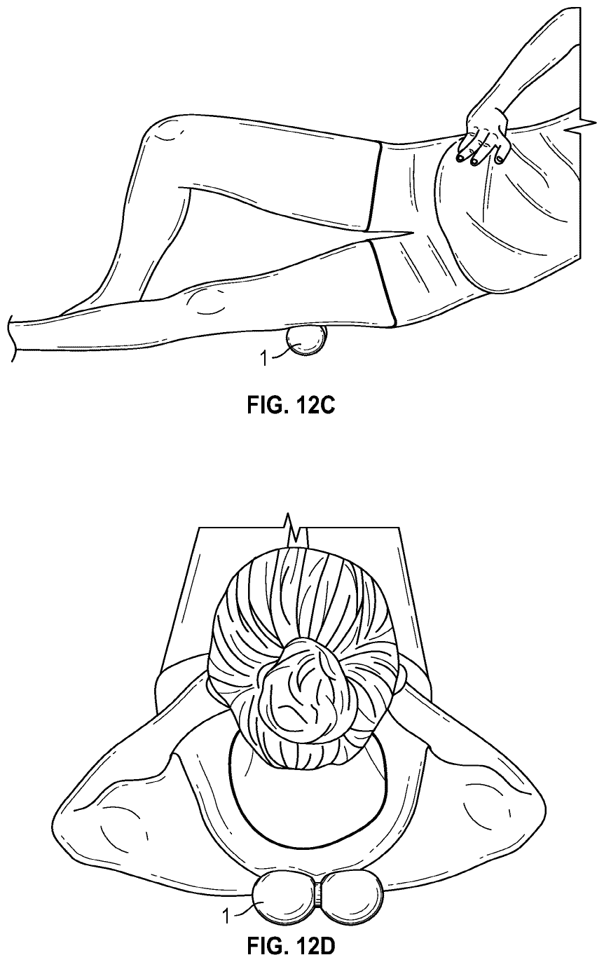

As generally shown in FIGS. 11-13, exemplary uses of a modular myofascial release device (1) according to various embodiments described herein. For example, in one embodiment user may place one or more compressive spheres (2) of the device in contact with one or more points on the body such as trigger points, myofascial fascial, or any other point or area for self-massage. In one example, the user may place the modular myofascial release device (1) such that the compressive spheres (2) generally contact portions of the user's back along the length of the spine. The user can then move in various directions their body parts that are pressing against the compressive spheres (2). This allows the user the ability to increase or decrease the amount of pressure that is being delivered to on anatomical feature, such as the lateral portion of the user's spine, or along a major muscle group or joint. In this manner, the user can deliver varying amounts of pressure to the desired areas on the body self-myofascial release, or for self-massage so there is no tension in the upper body allowing the hands free to be able to stretch the muscles while pressure is applied.

In another example, a first user may employ the help of a second user, such as a medical professional, in assisting them in applying pressure through the device to one or more anatomical features. One or more compressive spheres (2) of the device may be placed over a desired area on the first user's body and manipulated by a second user who may utilize the push or pull of the second user's body to increase or decrease the amount of pressure delivered to the body of the first user.

In a further embodiment, a user may move through a range of motions while one or more compressive spheres (2) of the device are pressed against an anatomical feature generating myofascial release or deep-tissue massage. For example, a user may place the compressive spheres (2) of the device over the left shoulder area or back, either directly by application of a modular myofascial release device (1), or through a compressive sphere (2) secured in a coupler (8) and secured to a surface. In this example, for example as shown in FIGS. 11-12, adequate tension is provided, the user can move the left shoulder or back through various ranges of motion while the compressive sphere(s) (2) press into the desired anatomical feature. This embodiment takes advantage of the ability to use the device in a self-directed manner, allowing a user freedom to move their limbs in various ranges of motion.

As used herein, the term “myofascial release” refers to any treatment or modality for the treatment of myofascial pain or myofascial pain syndrome. As used herein, myofascial pain includes pain and tenderness in the muscles and adjacent fibrous or connective tissues (called fascia). Typically, myofascial pain involves certain trigger points, or hard nodules in muscle tissue or tendons. Usually, the pain is a continuous dull pain in one or more muscles and patients with myofascial pain may have reproducible alteration of pain complaints with palpation of certain tender areas termed active trigger points. In some embodiments of myofascial pain, one or more trigger points or pain generators may cause muscle strain that may lead to pain and/or inflammation. Myofascial pain is the key cause of myofascial pain syndrome.

As used herein, “myofascial pain syndrome” describes a chronic non-degenerative, non-inflammatory musculoskeletal condition often associated with spasm or pain in the masticatory muscles. Distinct areas within muscles or their delicate connective tissue coverings (fascia) become abnormally thickened or tight. When the myofascial tissues tighten and lose their elasticity, the ability of neurotransmitters to send and receive messages between the brain and body is disrupted. Specific discrete areas of muscle may be tender when firm fingertip pressure is applied; these areas are called tender or trigger points. (Both areas are tender, but trigger points radiate the pain to a distant site.) Symptoms of myofascial pain syndrome include muscle stiffness and aching and sharp shooting pains or tingling and numbness in areas distant from a trigger point. The discomfort may cause sleep disturbance, fatigue and depression. Most commonly trigger points are in the jaw (temporomandibular) region, neck, back or buttocks.

As used herein, the term “myofascial release” also refers to any treatment or modality for “mobilization” and “joint mobilization” which includes a manual technique directed to the subject's joint whereby a clinician or device imparts passive or active movements. Joint mobilization is characterized by low-velocity movements that may relieve pain or improve range of motion by improving joint play and restoring the slide and glide arthrokinematics of the joint.

As used herein, the term “subject” means a human subject that may be in need of treatment for myofascial pain, joint mobilization, tissue massage or other therapeutic needs, may be susceptible to myofascial pain, joint destabilization/pain for which myofascial release, joint mobilization or tissue massage may provide a positive therapeutic outcome, or a may benefit from myofascial release, joint mobilization or tissue massage as a preventative treatment.

1-20. (canceled)

21. A therapeutic device comprising:
two compression spheres, each compression sphere of the two compression spheres being made from an elastomeric material and having an annular channel penetrating a portion of a length of each compression sphere; and
a hollow connector including an outer surface, which is cylindrical, and an inner surface, which is also cylindrical and spaced from the outer surface, the hollow connector being insertable into the annular channel of each compression sphere of the two compression spheres, and when the hollow connector is inserted into the annular channel of one compression sphere of the two compression spheres the hollow connector being secured in position by friction exerted by the elastomeric material of the one compression sphere on both the outer surface and the inner surface of the hollow connector.

22. The therapeutic device of claim 21, wherein when the hollow connector is inserted into the annular channel of the one compression sphere of the two compression spheres the hollow connector being secured in position by a compression force exerted by the elastomeric material of the one compression sphere on both the outer surface and the inner surface of the hollow connector.

23. The therapeutic device of claim 22, wherein when the hollow connector includes a recessed notch positioned adjacent a terminal end of the hollow connector, and when the hollow connector is inserted into the annular channel of the one compression sphere of the two compression spheres the elastomeric material of the one compression sphere conforms to the recessed notch.

24. The therapeutic device of claim 23, wherein the recessed notch is annular.

25. The therapeutic device of claim 23, wherein an extension is provided along a surface of the annular channel, the extension being configured to be mated with the recessed notch.

26. The therapeutic device of claim 25, wherein the recessed notch is annular, and wherein when the extension is annular.

27. The therapeutic device of claim 26, wherein the extension provided along the surface of the annular channel mates with the recessed notch on the outer surface of the hollow connector forming a connection preventing retraction of the hollow connector from the annular channel, and a predetermined lateral force on the one of the compression spheres or the hollow connector overcomes the frictional force holding the hollow connector in the annular channel.

28. A therapeutic device, comprising:
two compressive spheres, each defining an outside surface and a center, each sphere having a channel extending from each respective outside surface toward each respective center so that each respective channel is accessible from each respective outside surface; and
an elongated connector being sized and shaped to selectively engage, at a first magnitude of friction, within each respective channel of the two spheres to connect the two spheres and provide two connected spheres and the connector being of sufficient length to separate the two connected spheres a predetermined distance thereby exposing a portion of the connector between two connected spheres so that the two connected spheres can be used as a first therapeutic device;
wherein at least one of each respective sphere being selectively removable from the connector by applying sufficient lateral force between at least one sphere of the two spheres and the connector to overcome the first magnitude of friction, so that a separated sphere can be used alone as a second therapeutic device.

29. The therapeutic device of claim 28, wherein the connector is hollow including an outer surface, which is cylindrical, and an inner surface, which is also cylindrical and spaced from the outer surface.

30. The therapeutic device of claim 29, wherein the connector includes a recessed notch provided on the outer surface positioned adjacent a terminal end of the connector.

31. The therapeutic device of claim 30, wherein the recessed notch is annular.

32. The therapeutic device of claim 31, wherein an extension is provided along a surface of the channel, the extension being annular and configured to be mated with the recessed notch.

33. The therapeutic device of claim 32, wherein the extension provided along the surface of the channel mates with the recessed notch on the outer surface of the connector forming a connection preventing retraction of the connector from the channel, and the sufficient lateral force on the at least one sphere or the connector overcomes the first magnitude of friction holding the connector in the channel.

34. The therapeutic device of claim 33, wherein each sphere is made from an elastomeric material and each respective channel is an annular channel, when the connector is inserted into each channel of the two spheres the connector being secured in position by friction exerted by the elastomeric material of the respective sphere on both the outer surface and the inner surface of the connector.

35. The therapeutic device of claim 34, wherein when the connector is inserted into each channel of the two spheres the connector being secured in position by a compressive force exerted by the elastomeric material of the respective sphere on both the outer surface and the inner surface of the connector.

36. A therapeutic device comprising:
two compression spheres, each compression sphere of the two compression spheres being made from an elastomeric material and having an annular channel penetrating a portion of a length of each compression sphere, wherein an extension is provided along a surface of the annular channel; and
a hollow connector including an outer surface, an inner surface, which is spaced from the outer surface, and a recessed notch on the outer surface, the hollow connector being insertable into the annular channel of each compression sphere of the two compression spheres, and when the hollow connector is inserted into the annular channel of one compression sphere of the two compression spheres the hollow connector being secured in position by the elastomeric material of the extension of the one compression sphere conforming to the recessed notch.

37. The therapeutic device of claim 36, wherein the recessed notch is annular.
